(19) United States
(12) Patent Application Publication
(10) Pub. No.: US 2005/0094172 A1
(43) Pub. Date: May 5, 2005

(54) Linking font resources in a printing system

(75) Inventors: Jeffery A. Engelman, Mead, CO (US); Reinhard H. Hohensee, Boulder, CO (US); Terry S. Luebbe, Mantorville, MN (US); David E. Stone, Longmont, CO (US); John T. Varga, Longmont, CO (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/696,953

(22) Filed: Oct. 30, 2003

(51) Int. Cl. G06F 15/00

(52) U.S. Cl. 358/1.11

(57) ABSTRACT

A method, computer program product and system for switching fonts without embedding font switching commands in the data stream (logical description of the print document) between a client and a print server. The client in a printing system may receive a character where the character is a modified character in a base font resource or is a character to be added to or deleted from the base font resource. The client may create a font resource that includes the received character. The client may further link the created font resource with the base font resource or vice-versa thereby allowing a user to use both the characters in the base font resource and in the linked font resource as if they were a single font resource without building or buying a special purpose font resource. Consequently, font switching commands are no longer necessary to be embedded in the data stream.

### CROSS REFERENCE TO RELATED APPLICATIONS

The present invention is related to the following U.S. Patent Application which is incorporated herein by reference:

Ser. No. ______ (Attorney Docket No. BLD920030027US1) entitled “A Printing System That Manages Font Resources Using System Independent Resource References” filed ______.

### TECHNICAL FIELD

The present invention relates to the field of printing systems, and more particularly to a printing system that links font resources.

### BACKGROUND INFORMATION

Computer systems can generate output information in several ways, including video output and “hard copy” or printed output. Although more and more output consists of evanescent video screens, a large amount of data is still printed on paper and other permanent media. Therefore, there is a need for efficiently describing printed data and then printing a hard copy page from the print description. The printing is often performed by high-speed, high-volume printing systems which receive streams of encoded print data and utilize “intelligent” printers that can store commands and data. Such encoded print streams often include data for many printed pages. For example, a telephone company might print all of its telephone bills for a specified week with a single print stream. Each page in the print stream may be a telephone bill for a particular customer.

In such printing and presentation systems, fonts may be stored in a separate resource database. Such font resources enable a relatively small set of characters to be efficiently defined for printing and displaying. A font resource may define the encoding (mapping of values, called code points, to characters), the metrics (measurements of a character), glyph (actual image of a character) and descriptive attributes of a collection of related characters. For example, a typical Latin font contains approximately three hundred (300) characters including alphabetic, numeric, symbolic, punctuation and special drawing characters. A typical Japanese or Chinese font may contain thousands of characters. In another example, Unicode is a 16-bit character encoding standard that is capable of representing all of the world's languages, including non-Roman languages, such as Chinese, Japanese and Hindi. The Unicode standard can encode more than 1 million characters.

Each font resource has a limit on the number of addressable characters. That is, each font resource has a limit on the number of characters to be identified for printing and displaying. For example, TrueType font, an outline font technology (outline refers to defining the shapes of characters in terms of mathematically generated lines and curves rather than by patterns of dots), has a limit of 65,536 characters to be addressed.

However, there may be more characters to be addressed than allowable by a particular font resource. For example, there may be greater than 65,536 characters to support various Chinese applications and hence exceed the limit of the TrueType font resource. Since it exceeds the character set, a customer may have to build or buy a special purpose font that includes the additional characters and switch between the two fonts.

Further, if a customer wants to add a character to the font resource (referred to as a “user-defined character”), the customer is usually prevented from modifying the font resource due to the license from the manufacturer of the font resource. Similarly, if a customer wants to replace a character in the font resource because the character has an error, the customer is usually prevented from modifying the font resource due to the license from the manufacturer of the font resource. The customer may then have to build or buy a special purpose font that includes the additional or modified character as well as the other characters in that font resource. Furthermore, if a customer wants to delete a character in the font resource because the customer will not use the character, then the customer may have to build or buy a special purpose font that does not include the character the customer desires to delete.

Therefore, there is a need in the art for a print system that allows a user to effectively add to, delete from or modify the font resource without having to build or buy a special purpose font and without having to switch between the two fonts.

### SUMMARY

The problems outlined above may at least in part be solved in some embodiments by linking a font resource with the added or modified character(s) with a base font resource thereby allowing a user to use the both the characters in the base font resource and in the linked font resource as if they were a single font resource without building or buying a special purpose font resource. Further, the linked resource may include entries for characters to be deleted from the base font. These entries may be associated with metrics that ensure nothing is printed, e.g., character increment=0, and glyphs with no images.

In one embodiment of the present invention, a method for switching fonts without embedding font switch commands may comprise the step of receiving a character where the character is a modified character in a base font resource or is a character to be added to or deleted from the base font resource. The method may further comprise creating a font resource that comprises the received character. The method may further comprise linking the created font resource to the base font resource if the received character is a character to be added. The method may further comprise linking the base font resource to the created font resource if the received character is a character to be modified or deleted.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a printing system in accordance with an embodiment of the present invention;

FIG. 2 illustrates an embodiment of the present invention of a client in the printing system;

FIG. 3 illustrates an embodiment of the present invention of a print server in the printing system;

FIG. 4 illustrates an embodiment of the present invention of a resource library in the printing system;

FIG. 5 is a flowchart of a method for creating a new font resource that is linked to a base font resource in accordance with an embodiment of the present invention; and

FIG. 6 is a flowchart of a method for switching fonts without embedding font switching commands in the data in accordance with an embodiment of the present invention.

### DETAILED DESCRIPTION

The present invention comprises a method, computer program product and system for switching fonts without embedding font switching commands in the data. In one embodiment of the present invention, a client in a printing system may receive a character where the character is a modified character in a base font resource or is to be added to or deleted from the base font resource. The client may create a font resource that includes the received character. The client may link the created font resource with the base font resource if the received character is a character to be added. The client may further link base font resource with the created font resource if the received character is a character to be modified or deleted. In this manner, a user may be able to use both the characters in the base font resource and in the linked font resource as if they were a single font resource without building or buying a special purpose font resource. By allowing a user to use both the characters in the base font resource and in the linked font resource as if they were a single font, font switching commands are no longer necessary to be embedded in the data stream.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

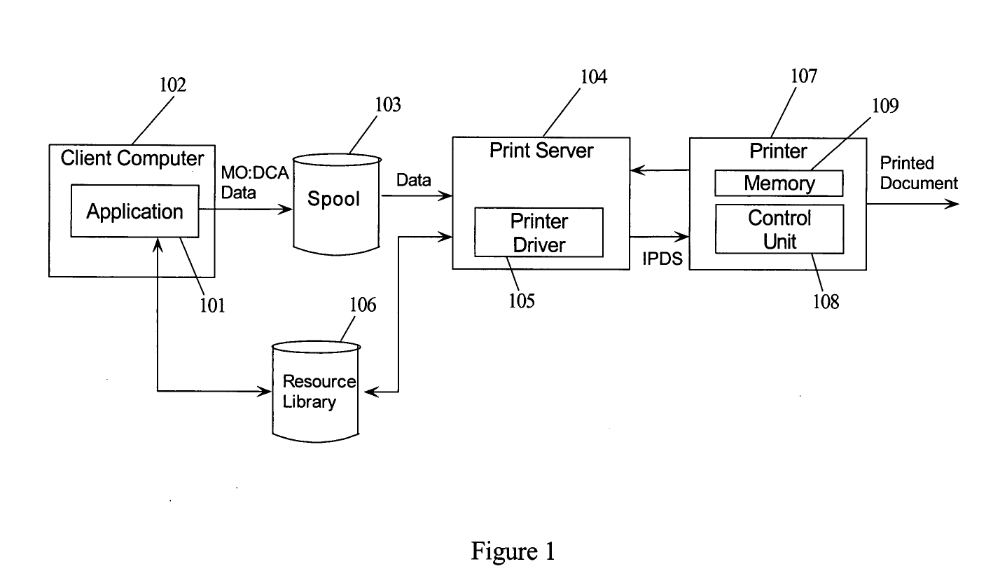

FIG. 1—Printing System

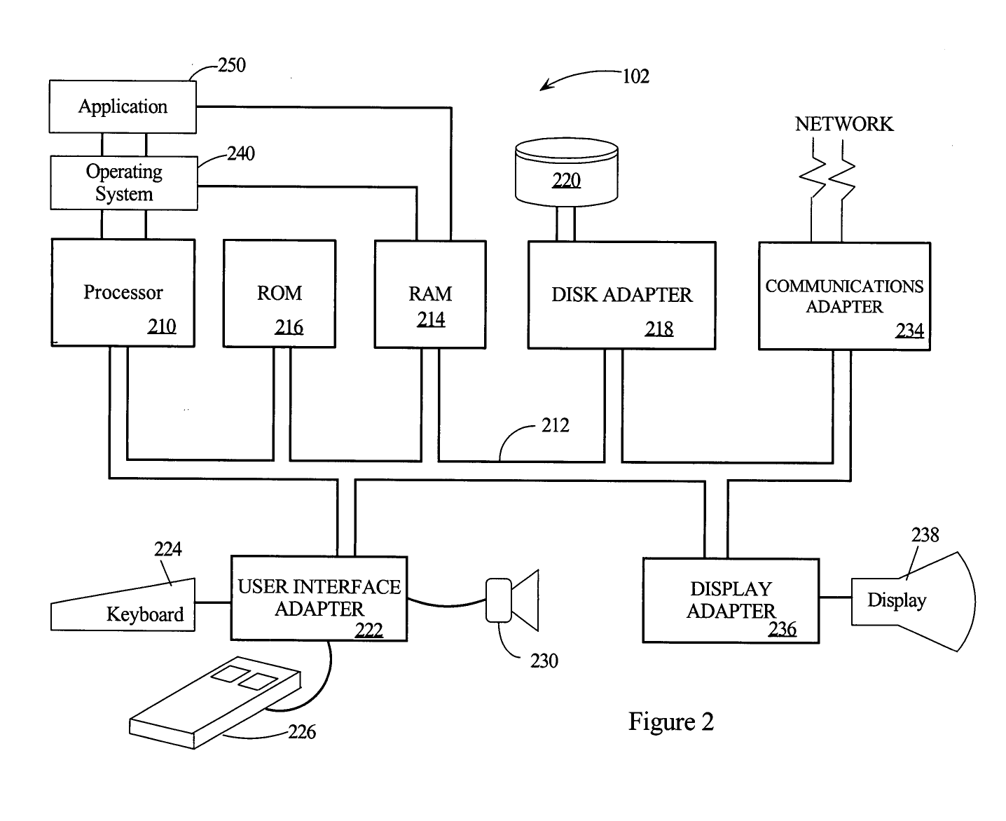

FIG. 1 illustrates an embodiment of the present invention of a printing system 100 for printing a document produced by an application program 101 (i.e., a “print document”) on a client computer 102. A more detailed description of client 102 is described further below in association with FIG. 2. The application program 101 running on client 102 generates a data stream that is a formatted, platform and a device independent logical description of the print document. One known specification of such a logical description of a data stream utilized for printing is known as MO:DCA (Mixed Object Document Content Architecture), described in detail in I.B.M. Mixed Object Document Content Architecture Reference number SC31-6802.

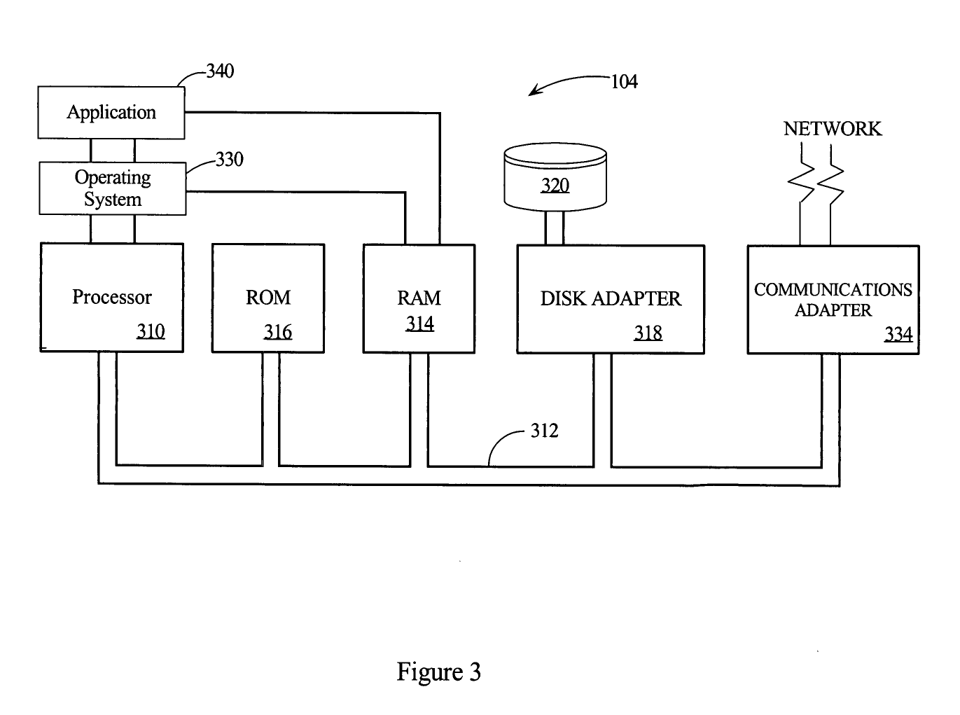

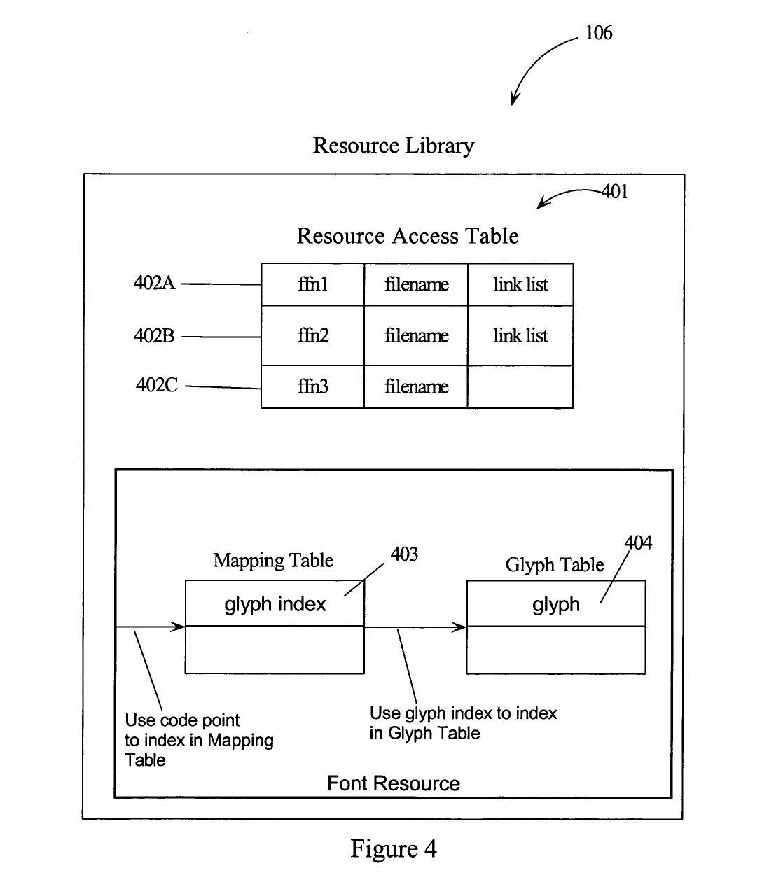

Printing system 100 further comprises a spool 103 for both receiving and spooling the data stream representing the print document from the application program 101. Once received by spool 103, the data stream is transmitted to a print server 104 that converts the data stream to a device specific data stream by means of a printer driver 105, and a resource library 106 containing resources such as fonts and print-control objects that are required to print the data stream. Application program 101 may be configured to access and use resource library 106 to format the document. A more detail description of print server 104 is provided further below in association with FIG. 3. A more detail description of resource library 106 is provided further below in association with FIG. 4. In the case where the MO:DCA printing format is used, the resulting data stream generated by print server 104 is called an Intelligent Printer Data Stream (IPDS). Use of print-control objects from resource library 106 in this manner is known in the art as “outboard formatting.” Resource library 106 is utilized in this manner to tie the logical page description of the print document to a physical medium and to allow formatting and printing processes to use the same resources. Once the data stream is converted, it is directed to a printer 107 for producing a printed document.

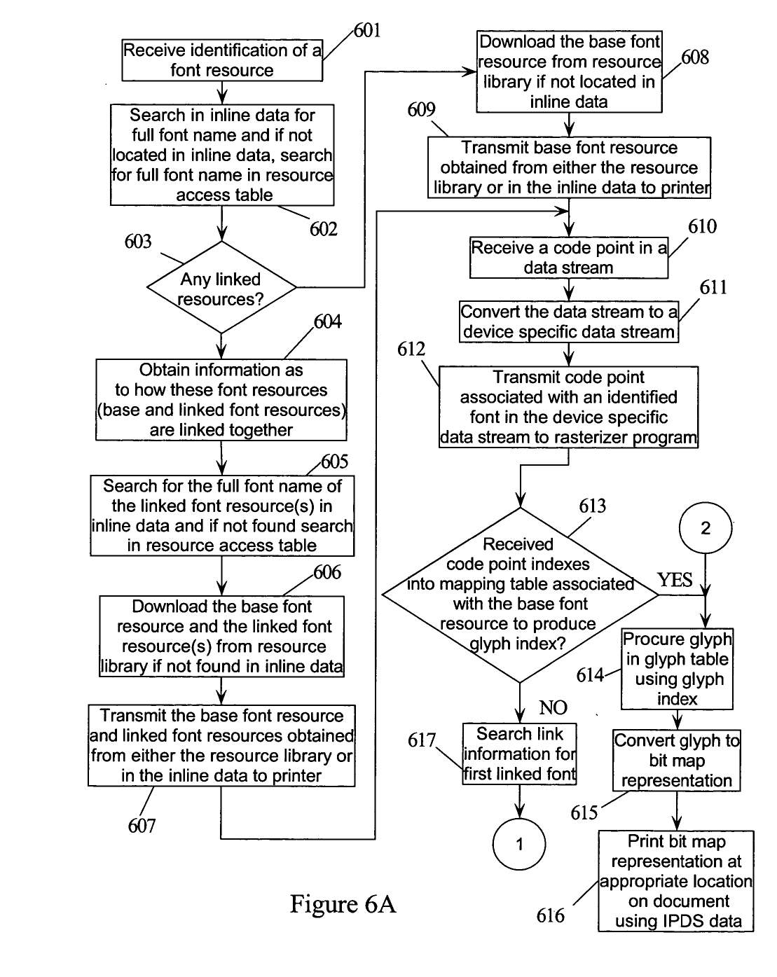

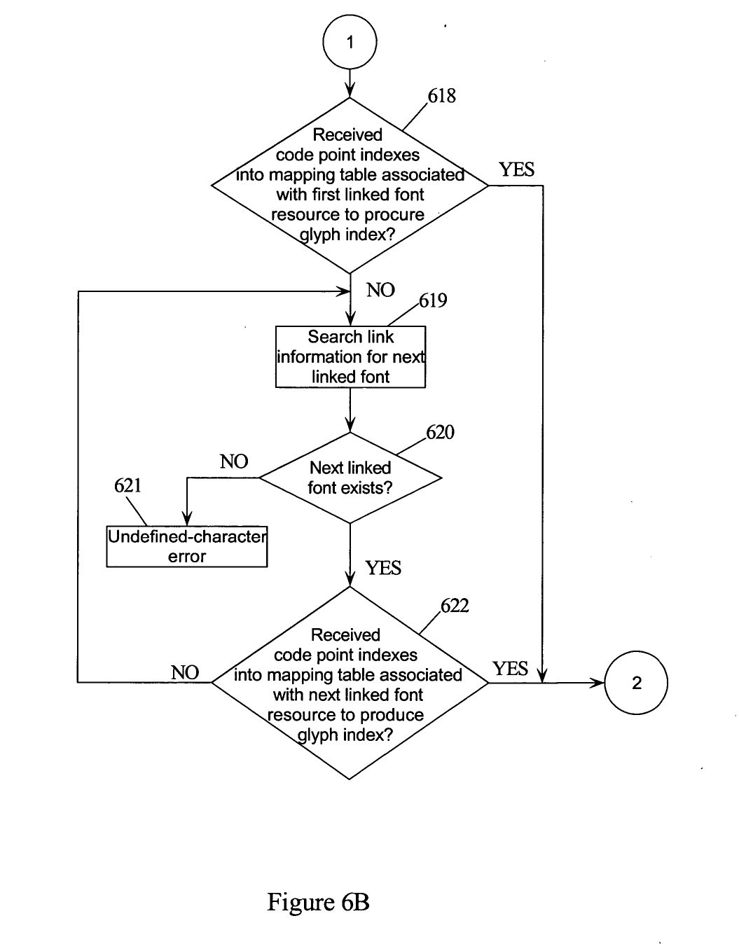

Printer 107 may have a control unit 108 with which print server 104 can communicate and an internal memory 109. The communication between print server 104 and printer 107 is bi-directional. For example, print server 104 may inquire of printer 107 whether a particular resource, such as a font, is resident in the printer memory 109. If the resource is not present, print server 104 may retrieve the font from resource database 106 and download it using the IPDS data stream into printer memory 109. The resource may then be available for future use. Subsequently, when print data that refers to the downloaded resource is received by printer 107, printer 107 will combine the resource with the data and provide the combination to a conventional Rasterizing Image Processor (called a “RIP”, not shown in FIG. 1) which converts the data into a printable graphic image. A rasterizer program used to convert the data into a printable graphic image, as described in further detail below in association with FIG. 6, may be stored in memory 109. Control unit 108 coupled to memory 109 may be configured to execute the instructions of the rasterizer program.

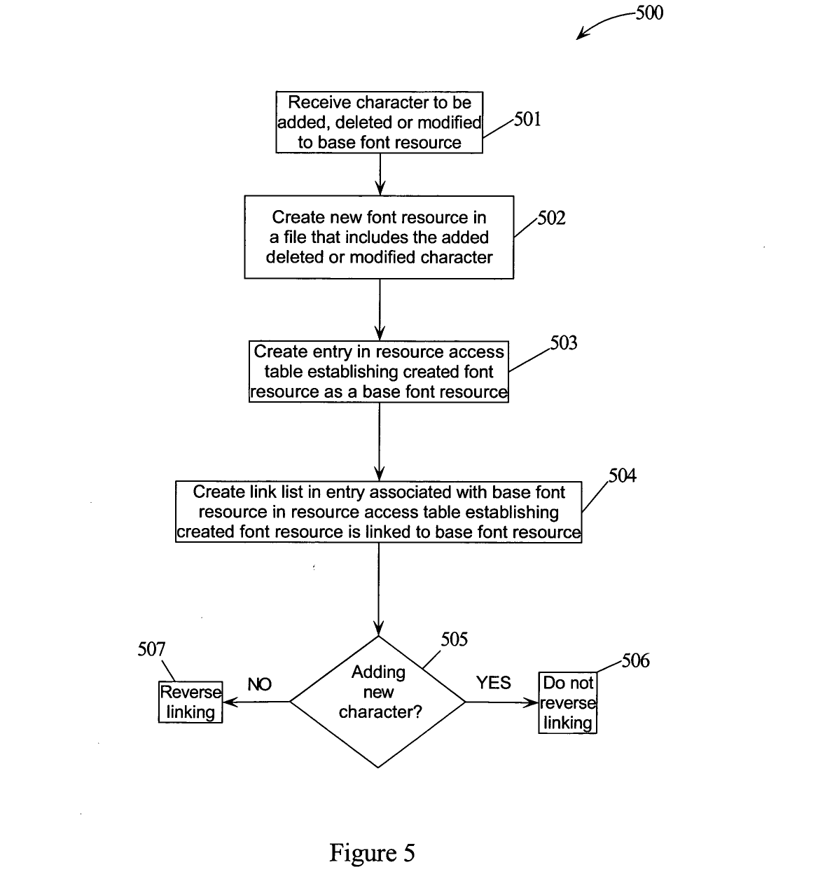

As stated above, there may be more characters to be addressed than allowable by a particular font resource. For example, there may be greater than 65,536 characters to support various Chinese applications and hence exceed the limit of the TrueType font resource. Since it exceeds the character set of a single font, a customer may have to build or buy a special purpose font that includes the additional characters and switch between the two fonts. Further, if a customer wants to add a character to the font resource (referred to as a “user-defined character”), the customer is usually prevented from modifying the font resource due to the license from the manufacturer of the font resource. Similarly, if a customer wants to replace a character in the font resource because the character has an error, the customer is usually prevented from modifying the font resource due to the license from the manufacturer of the font resource. The customer may then have to build or buy a special purpose font that includes the additional or modified character as well as the other characters in that font resource. Furthermore, if a customer wants to delete a character in the font resource because the customer will not use the character, then the customer may have to build or buy a special purpose font that does not include the character the customer desires to delete. Therefore, there is a need in the art for a print system that allows a user to effectively add to, delete from or modify the font resource without having to build or buy a special purpose font and without having to switch between the two fonts. A user may be able to add to, delete from or modify the font resource without having to build or buy a special purpose font by including a program, such as in client 102, configured to create a new font resource with the added or modified character that is linked to a base font resource. Further, the program, such as in client 102, may be configured to create a new font resource that includes entries for characters to be deleted from the base font. These entries may be associated with metrics that ensure nothing is printed, e.g., character increment=0, and glyphs with no images. By linking to the base font resource, a user may not have to build or buy a special purpose font resource and may avoid font switching in the application data stream. A more detailed description of the linking program in client 102 is described further below in association with FIGS. 2 and 5.

FIG. 2—Client

FIG. 2 illustrates a typical hardware configuration of client 102 (FIG. 1) which is representative of a hardware environment for practicing the present invention. Referring to FIG. 2, client 102 may have a processor 210 coupled to various other components by system bus 212. An operating system 240, may run on processor 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, a linking program for creating a new font resource with an added, deleted or modified character that is linked to a base font resource as discussed in association with FIG. 5. Application 250 may further include a program for generating a data stream that is a formatted, platform and device independent logical description of the print document, e.g., MO:DCA, as discussed in association with FIGS. 5 and 6. Application 250 may further include a program for accessing and using resource library 106 (FIG. 1) to format a document.

Read only memory (ROM) 216 may be coupled to system bus 212 and include a basic input/output system (“BIOS”) that controls certain basic functions of client 102. Random access memory (RAM) 214 and disk adapter 218 may also be coupled to system bus 212. It should be noted that software components including operating system 240 and application 250 may be loaded into RAM 214 which may be client's 102 main memory. Disk adapter 218 may be an integrated drive electronics (“IDE”) adapter that communicates with a disk unit 220, e.g., disk drive. It is noted that the program of the present invention that creates a new font resource with an added, deleted or modified character that is linked to a base font resource, as discussed in association with FIG. 5, may reside in disk unit 220 or in application 250. It is further noted that the program of the present invention that generates a data stream that is a formatted, platform and device independent logical description of the print document, e.g., MO:DCA, as discussed in association with FIGS. 5 and 6, may reside in disk unit 220 or in application 250.

Returning to FIG. 2, communications adapter 234 may also be coupled to system bus 212. Communications adapter 234 may interconnect bus 212 with an outside network enabling client 102 to communicate with spool 103 (FIG. 1), print server 104 (FIG. 1) and resource library 106 (FIG. 1). Input/Output devices may also be connected to system bus 212 via a user interface adapter 222 and a display adapter 236. Keyboard 224, mouse 226 and speaker 230 may all be interconnected to bus 212 through user interface adapter 222. Event data may be inputted to client 102 through any of these devices. A display monitor 238 may be connected to system bus 212 by display adapter 236. In this manner, a user is capable of inputting to client 102 through keyboard 224 or mouse 226 and receiving output from client 102 via display 238 or speaker 230.

Implementations of the invention include implementations as a computer system programmed to execute the method or methods described herein, and as a computer program product. According to the computer system implementations, sets of instructions for executing the method or methods may be resident in the random access memory 214 of one or more computer systems configured generally as described above. Until required by client 102, the set of instructions may be stored as a computer program product in another computer memory, for example, in disk unit 220. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3—Print Server

FIG. 3 illustrates an embodiment of the present invention of print server 104 (FIG. 1). Referring to FIG. 3, print server 104 may comprise a processor 310 coupled to various other components by system bus 312. An operating system 330 may run on processor 310 and provide control as well as coordinate the function of the various components of FIG. 3. An application 340 in accordance with the principles of the present invention may run in conjunction with operating system 330 and provide calls to operating system 330 where the calls implement the various functions or services to be performed by application 340. An application 340 may include, for example, a program for converting the data stream received from client 102 (FIGS. 1 and 2) to a device specific data stream, e.g., IPDS data stream, to be transmitted to printer 107 (FIG. 1), as discussed in association with FIG. 6. Application 340 may further include printer driver 105. Read only memory (ROM) 316 may be coupled to system bus 312 and include a Basic Input/Output System (“BIOS”) that controls certain basic functions of print server 104. Random access memory (RAM) 314, disk adapter 318 and communications adapter 334 may also be coupled to system bus 312. It should be noted that software components including operating system 330 and application 340 may be loaded into RAM 314 which may be the main memory for print server 104. Disk adapter 318 may be an integrated drive electronics (“IDE”) adapter that communicates with a disk unit 320. It is noted that the program of the present invention in print server 104 that converts the data stream received from client 102 to a device specific data stream, e.g., IPDS data stream, as discussed in association with FIG. 6, may reside in disk drive 320 or in application 340. Communications adapter 334 may enable print server 104 to communicate with printer 107 (FIG. 1), client 102 (FIGS. 1 and 2), resource library 106 (FIG. 1) and spool 103 (FIG. 1).

Implementations of the invention include implementations as a computer system programmed to execute the method or methods described herein, and as a computer program product. According to the server implementations, sets of instructions for executing the method or methods may be resident in the random access memory 314 of one or more computer systems configured generally as described above. Until required by print server 104, the set of instructions may be stored as a computer program product in another computer memory, for example, in disk drive 320 (which may include a removable memory such as an optical disk or floppy disk for eventual use in disk drive 320). Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

As stated above, print server 104 may access resource library 106 (FIG. 1) having print control functions to generate an IPDS data stream. Resource library 106 may further be configured to store font resources such as base and linked font resources as discussed below in association with FIG. 4.

FIG. 4—Resource Library

FIG. 4 illustrates an embodiment of the present invention of a resource library 106 (FIG. 1). As stated above, resource library 106 may further be configured to store font resources. These font resources may be linked with one another through a table, referred to herein as a “resource access table” 401, stored in resource library 106.

Referring to FIG. 4, resource access table 401 may comprise a plurality of entries 402A-C. Entries 402A-C may collectively or individually be referred to as entries 402 or entry 402, respectively. It is noted that resource access table may store any number of entries 402 and that FIG. 4 is illustrative.

Each entry 402 in resource access table 401 may include information regarding a particular base font resource. For example, each entry 402 may be associated with a particular base font resource which is identified by a unique “full font name” as illustrated in FIG. 4 by the letters “ffn.” For example, entry 402A provides information for the base font resource identified by ffn1. Entry 402B provides information for the base font resource identified by ffn2. Entry 402C provides information for the base font resource identified by ffn3.

Each base font resource may be stored in a file in resource library 106 which is identified by a file name. Further, if there are resources that are linked to the base font resource, then entry 402 may include a “link list” that contains a listing of one or more resources that are linked to the base font resource. The link list may further include information (“link information”) as to how these linked font resources are linked to other resources (linked or base font resource). Further, if the link list contains a listing of multiple linked font resources, then a linked font resource may be linked to the preceding listed linked font resource. For example, if the link list contained an ordered listing of linked font resource #1 followed by linked font resource #2, then linked font resource #2 is linked to linked font resource #1. In one embodiment, the linked resources may be identified by full font names in the link list. A more detail description of linked resources is provided below. Additional details regarding resource access table 401 and the information stored in each entry 402 are disclosed in U.S. application Ser. No. ______, filed on ______, entitled “A Printing System that Manages Font Resources Using System Independent References,” Attorney Docket No. BLD920030027US1, which is hereby incorporated herein by reference in its entirety.

As stated above, each base font resource may be associated with a unique entry 402 that includes its file name. The file name identifies the base font resource, as illustrated in FIG. 4, which includes a “mapping table” 403 and a “glyph table” 404, as discussed below. In particular, the file name may function as a pointer identifying a “mapping table” 403 in the base font resource. Mapping table 403 may be configured to store one or more glyph indexes that are used to index into a “glyph table” 404 in the base font source. An entry in mapping table 403 may be indexed using, what is referred to herein as a “code point,” that is stored in the IPDS data transmitted to printer 107 (FIG. 1). A code point may be a value that is used to identify a particular character. Glyph table 404 may be configured to store one or more glyphs of a particular font resource. In one embodiment, the linked font resources may be configured similarly as the base font resource by containing one or more mapping tables 403 that store glyph indexes used to index into one or more glyph tables 404. In one embodiment, the full font names used to identify the linked font resources may either be stored in resource access table 401 when the linked font resource is also defined as a base font resource or may be provided in the inline data as explained below.

In the MO:DCA data, information regarding font resources may be stored in a data structure referred to herein as a “resource group.” In the resource group, font resources may be identified by a native name such as a full font name. The resource group may be sent in the MO:DCA data prior to the document being sent by application program 101. Upon receiving the MO:DCA data from application program 101, print server 104 may identify any native names in the MO:DCA data. Upon identifying any native names in the MO:DCA data, then print server 104 may search for the file containing the font resource in the inline data (MO:DCA data). If the file is not contained in the inline data, then print server 104 may search for the file containing the font resource in resource access table 401. Printer server 104 may access a particular entry 402 in resource access table 401 using the received full font name. If the file is contained in the inline data, then print server 104 accesses the font source in the inline data. Further, the resource group may include a link list associated with a base font resource. If the resource group includes a link list identifying linked fonts by their native names, e.g., full font names, then print server 104 may first search for their files in the inline data and if they are not located in the inline data search for their files in resource access table 401 using their full font names.

As stated above, a user may be able to add a character, delete a character or modify a character in the base font resource without having to build or buy a special purpose font by including a linking program, as discussed below in association with FIG. 5, configured to create a new font resource with the added, deleted or modified character that is linked to another font resource. In the case of adding a character to the base font resource, the new font resource that includes the character to be added to the base font resource may be referred to herein as a “linked font.” In the case of modifying a character or deleting a character from the base font resource, the base font resource becomes the “linked font” resource. The created font resource that includes the modified or deleted character may then become the base font resource. Each linked font may be “linked” or associated with another font resource, such as a base font resource. For example, in the case of adding a character to the base font resource, the new font resource that includes the character to be added to the base font resource may be “linked” to the base font resource. In the case of modifying a character or deleting a character from the base font resource, the original base font resource may be “linked” to the created font resource (new base font resource) that includes the modified character or empty glyph associated with the deleted character.

By linking or associating the linked font resource to another font resource, the user in essence has a total font resource of the base font resource in addition to the added, deleted or modified character. Each linked font resource may also be linked or associated with other linked font resources thereby providing the user a total font resource of a base font resource in addition to multiple linked font resources that each store one or more added, deleted or modified characters. A more detail description of creating linked font resources as well as the mapping and glyph tables 403, 404, respectively, associated with the created linked font resources is described below in association with FIG. 5.

As will be described in greater detail below in association with FIG. 6, the rasterizer program stored in printer 107, in order to generate a bit map representation of a character to be printed by printer 107, may identify a mapping table 403 associated with the base font resource. The rasterizer program may attempt to index mapping table 403 associated with the base font resource using a received code point in the IPDS data stream received from print server 104 (FIGS. 1 and 3). As stated above, the code point is used to identify a particular character, e.g., “A.” However, if the code point does not index into mapping table 403, then the rasterizer program may proceed to the next entry 402, e.g., first linked font resource, in resource access table 401 storing a pointer to mapping table 403 associated with the resource identified in the next entry 402. The rasterizer program may attempt to index-mapping table 403 associated with the resource, e.g., the linked font resource, identified in the next entry using the received code point in the IPDS™ data stream received from print server 104 (FIGS. 1 and 3). The above outlined process continues until either the rasterizer program is able to index into mapping table 403 or there are no more font resources identified in resource access table 401.

FIG. 5—Method for Creating a New Font Resource with an Added Deleted or Modified Character that is Linked to a Base Font Resource

FIG. 5 is a flowchart of one embodiment of the present invention of a method 500 for creating a new font resource with an added, deleted or modified character that is linked to a base font resource.

Referring to FIG. 5, in association with FIGS. 1-4, in step 501, client 102 receives a character to be effectively added to, deleted from or modified in a base font resource, e.g., TrueType. For example, a user of client 102 may desire to add a logo, e.g., company logo, to the base font resource, e.g., TrueType. In another example, a user of client 102 may desire to delete a character, e.g., frown face, from the base font resource. In another example, a user of client 102 may desire to modify the base font resource by replacing a character that has an error with the correct character.

In step 502, client 102 creates a new font resource that includes the added, deleted or modified character, e.g., logo. The created font resource includes a mapping table 403 (FIG. 4) and a glyph table 404 (FIG. 4). Mapping table 403 may include a glyph index used to index into the created glyph table 404 which includes the character received in step 501. If the character received is a character to be deleted, then the glyph or character in glyph table 404 associated with that character may be empty. In this manner, the character to be deleted from the base font resource will not be printed.

In step 503, client 102 creates a new entry 402 in resource access table 401 identifying the font resource created in step 502. For example, the full font name of the created font resource and its associated file name may be stored in the created entry 402.

In step 504, client 102 further creates a link list in the entry 402 associated with the base font resource thereby linking the created font resource with the base font resource.

In step 505, client 102 determines if the character received in step 501 is a character to be added to the base font resource. If the character received in step 501 is a character to be added to the base font resource, then, in step 506, client 102 indicates in the entry 402 associated with the base font resource to not reverse the order of the linking. In one embodiment, client 102 may indicate to not reverse the order of the linking by not setting a bit. For example, if the character received in step 501 is a character to be added to the base font resource, then client 102 indicates in the entry 402 associated with the base font resource to not reverse the order of the linking. Consequently, the created font resource containing the added font resource is linked with the base font resource.

If, however, the character received in step 501 is not a character to be added to the base font resource, then, in step 507, client 102 indicates in the entry 402 associated with the base font resource to reverse the order of the linking. In one embodiment, client 102 may indicate to reverse the order of the linking by setting a bit. Consequently, the base font resource becomes linked to the font resource created in step 501. For example, if the character received in step 501 is a modified character or a character to be deleted from the base font resource, then client 102 indicates in the entry 402 associated with the base font resource to reverse the order of the linking. Consequently, the base font resource containing the character to be deleted or modified is linked with the created font resource.

It is noted that even though linking a created font resource with a base font resource is described with reference to using resource access table 401 that linking may be accomplished via inline data. That is, linking a created font resource with a base font resource may be accomplished via commands inserted in the data, e.g., MO:DCA, transmitted between client 102 and print server 104, instead of using resource access table 401. It is further noted that embodiments accomplishing linking through inline data would fall within the scope of the present invention.

It is further noted that method 500 may include other and/or additional steps that, for clarity, are not depicted. It is further noted that method 500 may be executed in a different order than presented and that the order presented in the discussion of FIG. 5 is illustrative. It is further noted that certain steps in method 500 may be executed in a substantially simultaneous manner.

FIG. 6—Method for Switching Fonts Without Embedding Font Switching Commands in the Data

FIG. 6 is a flowchart of one embodiment of the present invention of a method 600 for switching fonts without embedding font switching commands in the data, e.g., MO:DCA, transmitted to print server 104 (FIG. 1) by client 102 (FIG. 1). As in the Background Information section, a user may have to build or buy a special purpose font that includes a character to be added, deleted or modified from a base font resource. When a character from this special purpose font is to be printed, the new font resource had to be identified in the data stream, e.g., MO:DCA, transmitted to the print server from the application of the client. Typically, a command to switch to the new font resource is inserted in the data stream thereby allowing the print server to switch font resources. Upon switching font resources, the rasterizer program may then be allowed to print a character from the new font resource. However, by requiring such switching font commands, the application writer in the client must understand how each character is associated with a particular font resource which is time consuming and prone to errors. Therefore, there is a need in the art to be able to switch between different font resources without the insertion of font switching commands in the data. Method 600 addresses such a need by using the linked font resources created using method 500 as discussed above.

Referring to FIG. 6, in association with FIGS. 1-4, in step 601, printer driver 105 in print server 104 receives an identification, e.g., full font name, of a font resource, e.g., TrueType. In step 602, printer driver 105 in printer server 104 searches the inline data (MO:DCA data) for the full font name associated with the received identification. If the full font name is not located in the inline data, then printer driver 105 searches resource access table 401 for the full font name of the requested font resource by identifying an entry 402 containing a full font name that matches the received identification.

Upon identifying the full font name of a base font resource in either the inline data or in resource access table 401 that matches the received identification, then, in step 603, printer driver 105 determines if there is a link list associated with that base font resource in either the inline data or if not located in the inline data in resource access table 401. If there is a link list associated with that base font resource, then, in step 604, printer driver 105 obtains information (“link information”) as to how these font resources (base and linked font resources) are linked together in resource access table 401. In step 605, printer driver 105 searches for the full font name for the linked font resource(s) in the inline data and if the full font name is not located in the inline data then searches for the full font name in resource access table 401 (linked font resource may be defined as a base font resource in a separate entry 402). In step 606, printer driver 105 downloads the base font resource and the linked font resource(s) identified in the link list from resource library 106 if not located in the inline data. In step 607, printer driver 105 transmits the base font resource and the linked font resource(s) as well as the link information obtained from either resource library 106 or in the inline data to printer 107.

If, however, printer driver 105 determines there is not a link list associated with that base font resource, then, in step 608, printer driver 105 downloads the base font resource from resource library 106 if not located in the inline data. In step 609, printer driver 105 transmits the base font resource obtained from either resource library 106 or in the inline data to printer 107.

In step 610, printer driver 105 receives a code point, e.g., code to print the letter “A,” in a data stream from application 101 of client 102. As stated above, a code point may be a value that is used to identify a particular character.

In step 611, printer driver 105 converts the data stream to a device specific data stream, e.g., IPDS data stream, to be understood by printer 107. In one embodiment, printer driver 105 may convert the code point used to identify a character to be printed into a form understood by printer 107.

In step 612, printer driver 105 transmits a code point associated with an identified font resource in the device specific data stream, e.g., IPDS data stream, to the rasterizer program of printer 107.

In step 613, a determination is made by the rasterizer program as to whether the received code point indexes into mapping table 403 associated with the base font resource identified by the identification received in step 601 to procure a glyph index. As stated above, printer driver 105 had previously transmitted the downloaded base font resource, which includes mapping table(s) 403 and glyph table(s) 404, to printer 107.

If the code point indexes into mapping table 403, then, in step 614, the rasterizer program procures the glyph in glyph table 404 using the glyph index obtained in step 613. In step 615, the rasterizer program converts the glyph obtained from glyph table 404 to a bit map representation. In step 616, printer 107 prints the bit map representation at the appropriate location on document using the IPDS™ data.

If, however, the code point does not index into mapping table 403, then, in step 617, the rasterizer program searches the link information provided in step 607 for a first linked font. The first linked font may refer to the linked font resource that is directly linked to the base font resource. In one embodiment, the first linked font may refer to the first linked font resource listed in the link list.

In step 618, a determination is made by the rasterizer program as to whether the received code point indexes into mapping table 403 associated with the first linked resource to procure a glyph index. As stated above, printer driver 105 had previously transmitted the downloaded linked font resource, which includes mapping table(s) 403 and glyph table(s) 404, to printer 107.

If the code point indexes into mapping table 403, then, in step 614, the rasterizer program procures the glyph in glyph table 404 using the glyph index obtained.

If, however, the code point does not index into mapping table 403, then, in step 619, the rasterizer program searches the link information provided in step 607 for the next linked font. The next linked font may refer to the next linked font resource listed in the link list.

In step 620, a determination is made by the rasterizer program as to whether there exists a next linked font resource identified in resource access table 401.

If a next linked font resource is not identified, then, in step 621, the rasterizer program outputs an undefined character error. An undefined character error may occur when an image of a character requested to be printed by application 101 of client 102 has not been stored in a glyph table 404.

If, however, a next linked font resource is identified, then, in step 622, a determination is made by the rasterizer program as to whether the received code point indexes into mapping table 403 associated with the next linked resource to procure a glyph index.

If the code point indexes into mapping table 403 associated with the next linked font resource, then, in step 614, the rasterizer program procures the glyph in glyph table 404 using the glyph index obtained.

If, however, the code point does not index into mapping table 403 associated with the next linked font resource, then, in step 619, the rasterizer program searches the link information provided in step 607 for the next linked font.

It is noted that method 600 may include other and/or additional steps that, for clarity, are not depicted. It is further noted that method 600 may be executed in a different order presented and that the order presented in the discussion of FIG. 6 is illustrative. It is further noted that certain steps in method 600 may be executed in a substantially simultaneous manner.

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for switching fonts without embedding font switches in the data comprising the steps of:
receiving a character, wherein said character is a modified character in a first base font resource or a character to be added to or deleted from said first base font resource;
creating a font resource that comprises said character;
linking said created font resource to said first base font resource if said character is a character to be added; and
linking said first base font resource to said created font resource if said character is a character to be modified or deleted.

2. The method as recited in claim 1 further comprising the steps of:
creating an entry in a first table indicating said created font resource is a second base font resource; and
creating a second and a third table associated with said created font resource, wherein said second table maps code points to glyph indexes, wherein said third table comprises glyphs

3. The method as recited in claim 2 further comprising the steps of:
creating a link list in an entry in said first table associated with said first base font resource to link said created font resource to said first base font resource;
indicating in said entry in said first table associated with said first base font resource to not reverse linking of said first base font resource to said created font resource if said character is a character to be added; and
indicating in said entry in said first table associated with said first base font resource to reverse linking of said first base font resource to said created font resource if said character is a character to be modified or deleted.

4. The method as recited in claim 3 further comprising the steps of:
receiving an identification of a font resource and a code point; and
transmitting said code point to a rasterizer program associated with said identified font resource.

5. The method as recited in claim 4, wherein said first base font resource is associated with a fourth table and a fifth table, wherein said fourth table maps code points to glyph indexes, wherein said fifth table comprises glyphs.

6. The method as recited in claim 5 further comprising the step of:
determining if said code point indexes in said fourth table;
wherein if said code point indexes in said fourth table, then the method further comprises the steps of:
procuring a glyph from said fifth table using a glyph index obtained from said fourth table;
converting said glyph to a bit map representation; and
transmitting said bit map representation to a printer; and
wherein if said code point does not index in said fourth table, then the method further comprises the step of:
determining if said code point indexes in said second table.

7. The method as recited in claim 5 further comprising the step of:
determining if said code point indexes in said second table;
wherein if said code point indexes in said second table, then the method further comprises the steps of:
procuring a glyph from said third table using a glyph index obtained from said second table;
converting said glyph to a bit map representation; and
transmitting said bit map representation to a printer; and
wherein if said code point does not index in said second table, then the method further comprises the step of:
determining if said code point indexes in said fourth table.

8. A computer program product embodied in a machine readable medium for switching fonts without embedding font switches in the data comprising the programming steps of:
receiving a character, wherein said character is a modified character in a first base font resource or a character to be added to or deleted from said first base font resource;
creating a font resource that comprises said character;
linking said created font resource to said first base font resource if said character is a character to be added; and
linking said first base font resource to said created font resource if said character is a character to be modified or deleted.

9. The computer program product as recited in claim 10 further comprising the programming steps of:
creating an entry in a first table indicating said created font resource is a second base font resource; and
creating a second and a third table associated with said created font resource, wherein said second table maps code points to glyph indexes, wherein said third table comprises glyphs

10. The computer program product as recited in claim 10 further comprising the programming steps of:
creating a link list in an entry in said first table associated with said first base font resource to link said created font resource to said first base font resource;
indicating in said entry in said first table associated with said first base font resource to not reverse linking of said first base font resource to said created font resource if said character is a character to be added; and
indicating in said entry in said first table associated with said first base font resource to reverse linking of said first base font resource to said created font resource if said character is a character to be modified or deleted.

11. The computer program product as recited in claim 10 further comprising the programming steps of:
receiving an identification of a font resource and a code point; and
transmitting said code point to a rasterizer program associated with said identified font resource.

12. The computer program product as recited in claim 11, wherein said first base font resource is associated with a fourth table and a fifth table, wherein said fourth table maps code points to glyph indexes, wherein said fifth table comprises glyphs.

13. The computer program product as recited in claim 12 further comprising the programming step of:
determining if said code point indexes in said fourth table;
wherein if said code point indexes in said fourth table, then the computer program product further comprises the programming steps of:
procuring a glyph from said fifth table using a glyph index obtained from said fourth table;
converting said glyph to a bit map representation; and
transmitting said bit map representation to a printer; and
wherein if said code point does not index in said fourth table, then the computer program product further comprises the programming step of:
determining if said code point indexes in said second table.

14. The computer program product as recited in claim 13 further comprising the programming step of:
determining if said code point indexes in said second table;
wherein if said code point indexes in said second table, then the computer program product further comprises the programming steps of:
procuring a glyph from said third table using a glyph index obtained from said second table;
converting said glyph to a bit map representation; and
transmitting said bit map representation to a printer; and
wherein if said code point does not index in said second table, then the computer program product further comprises the programming step of:
determining if said code point indexes in said fourth table.

15. A system, comprising:
a client configured to generate a first data stream comprising page description information;
a spool coupled to said client, wherein said spool is configured to store said first data stream;
a resource library configured to store a first base font resource;
a print server coupled to said spool and said resource library, wherein said print server comprises:
a first memory unit operable for storing a printer driver configured to generate a second data stream; and
a first processor coupled to said first memory unit; and
a printer coupled to said print server, wherein said printer is configured to receive said second data stream generated from said print server, wherein said printer comprises:
a second memory unit operable for storing a rasterizer program; and
a control unit coupled to said second memory unit;
wherein said client comprises:
a third memory unit operable for storing a computer program for creating a linked resource;
a second processor coupled to said second memory unit, wherein said second processor, responsive to said computer program, comprises:
circuitry operable for receiving a character, wherein said character is a modified character in said first base font resource or a character to be added to or deleted from said first base font resource;
circuitry operable for creating a font resource that comprises said character;
circuitry operable for linking said created font resource to said first base font resource if said character is a character to be added; and
circuitry operable for linking said first base font resource to said created font resource if said character is a character to be modified or deleted.

16. The system recited in claim 15, wherein said resource library comprises a first table, wherein said second processor further comprises:
circuitry operable for creating an entry in said first table indicating said created font resource is a second base font resource; and
circuitry operable for creating a second and a third table associated with said created font resource to be stored in said resource library, wherein said second table maps code points to glyph indexes, wherein said third table comprises glyphs.

17. The system as recited in claim 16, wherein said resource library comprises a first table, wherein said second processor further comprises:
circuitry operable for creating a link list in an entry in said first table associated with said first base font resource to link said created font resource to said first base font resource;
circuitry operable for indicating in said entry in said first table associated with said first base font resource to not reverse linking of said first base font resource to said created font resource if said character is a character to be added; and
circuitry operable for indicating in said entry in said first table associated with said first base font resource to reverse linking of said first base font resource to said created font resource if said character is a character to be modified or deleted.

18. The system as recited in claim 17, wherein said first processor, responsive to said printer driver, comprises:
circuitry operable for receiving an identification of a font resource and a code point; and
circuitry operable for transmitting said code point to said rasterizer program associated with said identified font resource.

19. The system as recited in claim 18, wherein said resource library stores a fourth table and a fifth table associated with said first base font resource, wherein said fourth table maps code points to glyph indexes, wherein said fifth table comprises glyphs.

20. The system as recited in claim 19, wherein said control unit, responsive to said rasterizer program, comprises:
circuitry operable for determining if said code point indexes in said second table;
wherein if said code point indexes in said second table, then said control unit, responsive to said rasterizer program, further comprises:
circuitry operable for procuring a glyph from said third table using a glyph index obtained from said second table;
circuitry operable for converting said glyph to a bit map representation; and
circuitry operable for transmitting said bit map representation to a printer; and
wherein if said code point does not index in said second table, then said control unit, responsive to said rasterizer program, further comprises:
circuitry operable for determining if said code point indexes in said fourth table.

21. The system as recited in claim 19, wherein said control unit, responsive to said rasterizer program, comprises:
circuitry operable for determining if said code point indexes in said fourth table;
wherein if said code point indexes in said fourth table, then said control unit, responsive to said rasterizer program, further comprises:
circuitry operable for procuring a glyph from said fifth table using a glyph index obtained from said fourth table;
circuitry operable for converting said glyph to a bit map representation; and
circuitry operable for transmitting said bit map representation to a printer; and
wherein if said code point does not index in said fourth table, then said control unit, responsive to said rasterizer program, further comprises:
circuitry operable for determining if said code point indexes in said second table.

22. A method for switching fonts without embedding font switches in the data comprising the steps of:
receiving an identification of a font resource;
searching in the inline data for a native name associated with said font resource; and
searching a table for said native name associated with said font resource if said native name is not located in said inline data.

23. The method as recited in claim 22 further comprising the steps of:
searching in said inline data for a link list associated with said font resource; and
searching in said table for said link list associated with said font resource if said link list is not located in said inline data;
searching for a native name associated with any linked font resources identified in said link list in said inline data; and
searching for said native name associated with any linked font resources identified in said link list in said table if said native name is not located in said inline data.

24. A computer program product embodied in a machine readable medium for switching fonts without embedding font switches in the data comprising the programming steps of:
receiving an identification of a font resource;
searching in the inline data for a native name associated with said font resource; and
searching a table for said native name associated with said font resource if said native name is not located in said inline data.

25. The computer program product as recited in claim 24 further comprising the programming steps of:
searching in said inline data for a link list associated with said font resource; and
searching in said table for said link list associated with said font resource if said link list is not located in said inline data;
searching for a native name associated with any linked font resources identified in said link list in said inline data; and
searching for said native name associated with any linked font resources identified in said link list in said table if said native name is not located in said inline data.

26. A system, comprising:
a client configured to generate a first data stream comprising page description information;
a spool coupled to said client, wherein said spool is configured to store said first data stream;
a resource library configured to store font resources;
a print server coupled to said spool and said resource library, wherein said print server comprises:
a memory unit operable for storing a printer driver configured to generate a second data stream; and
a processor coupled to said first memory unit;
wherein said processor, responsive to said printer driver, comprises:
circuitry operable for receiving an identification of a font resource;
circuitry operable for searching in said first data stream for a native name associated with said font resource; and
circuitry operable for searching a table in said resource library for said native name associated with said font resource if said native name is not located in said first data stream.

27. The system as recited in claim 26, wherein said processor, responsive to said printer driver, comprises:
circuitry operable for searching in said first data stream for a link list associated with said font resource; and
circuitry operable for searching in said table in said resource library for said link list associated with said font resource if said link list is not located in said first data stream;
circuitry operable for searching for a native name associated with any linked font resources identified in said link list in said first data stream; and
circuitry operable for searching for said native name associated with any linked font resources identified in said link list in said table if said native name is not located in said first data stream.
